(19) United States
(12) Patent Application Publication
(10) Pub. No.: US 2016/0378185 A1
(43) Pub. Date: Dec. 29, 2016

(54) INTEGRATION OF HEADS UP DISPLAY WITH DATA PROCESSING

(71) Applicants: Rustom Mody, Bellaire, TX (US); Joel Tarver, Houston, TX (US); Greg Folks, The Woodlands, TX (US); Mathias Schlecht, Kingwood, TX (US); Harold Brannon, Magnolia, TX (US); Erik Nordenstam, The Woodlands, TX (US); Timothy M. Donoughue, The Woodlands, TX (US)

(72) Inventors: Rustom Mody, Bellaire, TX (US); Joel Tarver, Houston, TX (US); Greg Folks, The Woodlands, TX (US); Mathias Schlecht, Kingwood, TX (US); Harold Brannon, Magnolia, TX (US); Erik Nordenstam, The Woodlands, TX (US); Timothy M. Donoughue, The Woodlands, TX (US)

(73) Assignee: Baker Hughes Incorporated, Houston, TX (US)

(21) Appl. No.: 15/190,694

(22) Filed: Jun. 23, 2016

Related U.S. Application Data
(60) Provisional application No. 62/183,894, filed on Jun. 24, 2015.

(51) Int. Cl. G06F 3/01; G06F 3/0346

(52) U.S. Cl. CPC G06F 3/014; G06F 3/0346; G06F 3/017

(57) ABSTRACT

A wearable information gathering and processing system is described. The system includes an information obtaining device, the information obtaining device including at least one of a radio frequency identification (RFID) reader, an infra red (IR) detector, a global positioning system (GPS) receiver, a laser measurement device, microphone, or camera. The system also includes a processing device, the processing device including at least one of a voice recognition processor, a gesture recognition processor, or data processor, and an information-providing device coupled to the processing device, the information-providing device including at least one of a heads up display, a speaker, or a vibrator.

### CROSS REFERENCE TO RELATED APPLICATIONS

This application claims the benefit of an earlier filing date from U.S. Provisional Application Ser. No. 62/183,894 filed Jun. 24, 2015, the entire disclosure of which is incorporated herein by reference.

### BACKGROUND

In large scale industries, such as the oil and gas industry, large volumes and varieties of information are collected, processed, and presented to help make decisions. In addition, information must be provided or exchanged for the safety and security of workers in environments that are not amenable to conventional forms of communication. For example, when a hazardous condition arises on an oil rig, a broadcast over a public announcement system may not be effective due to noisy equipment. In addition, grease and other debris on workers hands may prevent effective use of communication devices that require typing or touchscreens.

### SUMMARY

According to an exemplary embodiment, a wearable information gathering and processing system includes an information obtaining device, the information obtaining device including at least one of a radio frequency identification (RFID) reader, an infra red (IR) detector, a global positioning system (GPS) receiver, a laser measurement device, microphone, or camera; a processing device, the processing device including at least one of a voice recognition processor, a gesture recognition processor, or data processor; and an information-providing device coupled to the processing device, the information-providing device including at least one of a heads up display, a speaker, or a vibrator.

### BRIEF DESCRIPTION OF THE DRAWINGS

Referring now to the drawings wherein like elements are numbered alike in the several Figures:

FIG. 1 illustrates a data collection, processing, and presentation system 100 according to embodiments of the invention;

FIG. 2 depicts a glove with sensors that facilitate interaction with the system according to embodiments of the system;

FIG. 3 depicts boots including sensors and devices according to embodiments of the invention; and

FIG. 4 depicts a suit including sensors and devices according to embodiments of the invention.

### DETAILED DESCRIPTION

As noted above, information collection and processing is important in many industries including the oil and gas industry. The development of wearable technologies such as GOOGLE GLASS, for example, facilitates the integration and management of information in ways that could not have previously been imagined. Embodiments of the systems and methods described herein relate to collection, processing, and presentation of information.

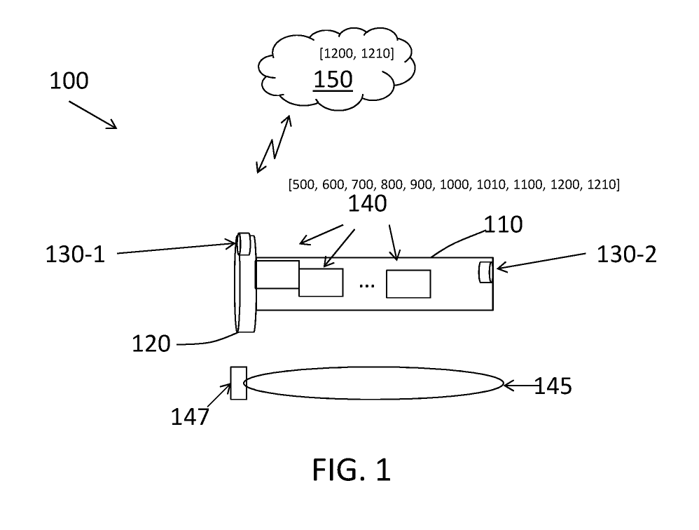

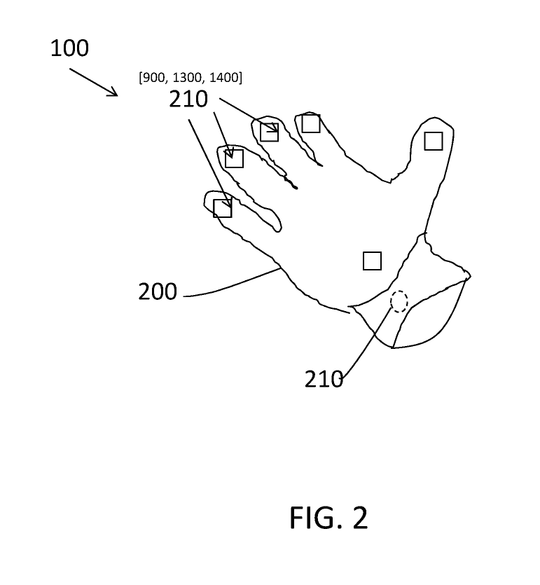

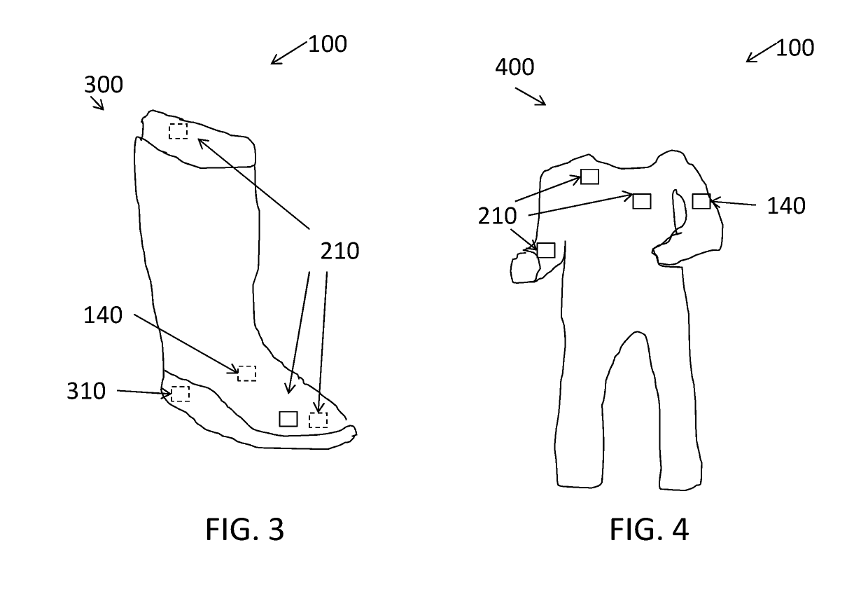

FIG. 1 illustrates a data collection, processing, and presentation system 100 according to embodiments of the invention. A band 110 coupled to a visualization screen or glasses 120 (a heads up display) is shown. In alternate embodiments, a helmet with a visor may be employed instead of the band 110 and glasses 120 or a fully integrated suit that includes a heads up display and data gathering and processing devices may be used. For explanatory purposes, the system 100 is discussed separately from a fully integrated wearable ensemble (glove 200 (FIG. 2), boots 300 (FIG. 3), suit 400 (FIG. 4)) here. The system 100 includes a front camera 130-1 and a rear camera 130-2 and one or more other sensors or devices 140. One device 140 shown coupled to a throat band 145 is a throat microphone 147.

For example, the devices 140 may include a radio frequency identification (RFID) chip 500 as well as an RFID reader 600. That is, according to one embodiment, the wearer of the system 100 may be identified based on an RFID chip 500. The system 100 may include an automatic identification and data capture (AIDC) capability that facilitates identification of the system 100 (and, in turn, its wearer) without human intervention. Additionally, as part of the AIDC capability, the system 100 may include other devices 140 (e.g., global positioning system (GPS) receiver 700 that provide location as well as identification. Various uses of the location information for the system 100 are discussed below. Alternately or additionally, the system 100 may read RFID data from other objects based on including an RFID reader 600. According to this embodiment, the system 100 could perform inventory control or invoicing, for example. The system 100 could also obtain information (e.g., about the security level of an individual with an RFID chip 500) based on reading that information with the RDID reader 600. Two or more systems 100 may be used for triangulation to get a more accurate location for an object that may have been detected by the RFID reader 600, for example. Two or more systems 100 may be synchronized with each other and with other components of the site in which the wearers of the systems 100 are located. The synchronization might facilitate data sharing or shared completion of a document. For example, if each wearer of each system 100 completed part of an electronic checklist, synchronizing the systems 100 would fill the uncompleted portion of the checklist for each wearer and result in one comprehensive document. The synchronization may serve as a proximity alert, as well.

Devices 140 may include data gathering devices for use by the system 100 or, additionally or alternatively, for transmission by the system 100 over a wireless network 150, for example. Exemplary devices 140, in addition to the cameras 130 and RFID reader 600, include a laser measurement device 800, gesture sensor 900 (which may also be among the sensors 210 associated with the glove 200, FIG. 2) that may be a processor integrated with the camera 130, a voice recognition processor 1000 coupled with the throat microphone 147 shown in FIG. 1, and an infrared (IR) sensor 1100. The laser measurement device 800 may be used to measure distances to and between objects. For example, the laser measurement device 800 may be used to verify required spacing between objects. The measurement from the laser measurement device 800 may be broadcast or transmitted over the network 150 and recorded. The device 140 used as a gesture sensor 900 may be used to control functionality of the system 100 itself or aspects of systems and components (e.g., of an oil rig on which the wearer works) external to the system 100. In addition, the gestures may be transmitted, for example, to other wearers of systems 100. In a noisy environment in which individuals cannot hear each other, for example, the wearers of the system 100 may instead exchange gestures (captured via their devices 140) or messages indicated by the gestures (through processing with devices 140 within the system 100) that are displayed on the glasses 120 of another wearer who may not be looking at the wearer making the gestures. The voice recognition processor 1000 may be used to identify the wearer or an individual or wearer of a different system 100. The throat microphone 147 may provide input to the voice recognition processor 1000 to identify the wearer of the system 100. This identification may be transmitted over the network 150 such that wearers (and their locations, for example) may be tracked. Alternately, a microphone 1010 of a first system 100 may be used to pick up the voice of the wearer of another system 100 or an individual not wearing a system 100, and the voice recognition processor 1000 of the first system 100 may ascertain the identify of the wearer of the other system 100 or the individual. This functionality may be used in an environment in which vision is affected by gasses or other environmental factors or in an environment in which individuals may not know each other on sight. The voice recognition processor 1000 may be coupled with a different processor (e.g., RFID reader 600, processing device 1200) of the system 100 or over the network 150 to obtain security level, classification, and other information about the individual identified by voice and to verify identification (i.e., ensure that the RFID reader 600 and voice recognition processor 1000 identify the same individual). The IR sensor 1100 may be embedded in the glasses 120, for example. As one exemplary use, the IR sensor 1100 may be used to monitor temperature and size of the heat effected area during welding so that adjustments could be made to the welding process, as needed.

Any of the devices 140 may perform continuous data collection and, thus, surveillance of a site. The status of tools in an area may be determined and monitored based on this data collection, for example. The tool status monitoring may include interaction between the system 100 and the tool being monitored. Integration among devices 140 may include a context-camera (CTX) such that images obtained by one of the cameras 130 is integrated with stored information (stored in memory 1210, for example) to provide a correlated image. That is, generally, an image or video may be captured with a camera 130 to determine (with a processing device 1200 that is one of the devices 140 of the system 100 or associated with the network 150) location and the presence of individuals or objects regarding which context information is available. For example, a stored animated image corresponding in some way with the image being captured by a camera 130 may be overlaid on the glasses 120 (i.e., glasses 120 facilitate augmented reality). Exits and the status of exits (e.g., green display if the exit is safe for use, red display if the exit is not usable) may be displayed. During an emergency, additional information (e.g., safety protocol, procedure) or operational alarms may be displayed as overlaid information. Any and all of the information from the various devices 140 may be integrated. For example, location information obtained from a GPS receiver 700 may be combined with the camera 130 data and context-camera functionality such that the exit or emergency information provided, for example, is specific to the location of the wearer of the system 100.

The location information from the GPS receiver 700 may be combined with information received over the network 150 (e.g., map information with identified zones) or identification information gathered with other devices 140 to provide a proximity alarm, for example, based on the wearer of the system 100 entering a hazardous or unauthorized area of a site. Automated processes may be coupled to information gathered by the devices 140. Based on identification or location determined by one or more of the devices 140, parameters measured by one or more devices 140, or other information transmitted by a wearer of another system 100, one or more components of the site where the wearer of the system 100 is located may be automatically shutdown, for example. Another automated process may be job tracking. That is, devices 140 of the system 100 may track tasks associated with a particular job with or without explicit input from the wearer of the system 100. According to embodiments, certain gestures may be recognized (using the gesture sensor 900) as being associated with completion of tasks or image processing may be used based on images captured by the cameras 130. Based on determining completion of the job, an automated process to submit a bill or invoice may be initiated (e.g., by a processing device 1200). Images or other proof of completion gathered by one or more devices 140 may be submitted along with the invoice. A running total of work to date may be maintained and a signal provided when a credit or similar financial limit is reached.

FIG. 2 depicts a glove 200 with sensors 210 that facilitate interaction with the system 100 according to embodiments of the system. The glove 200 and the devices 140 of the system 100 may interact through the network 150 or may be coupled by a hardwired connection. The sensors 210 may include touch sensors 1300. The sensors 210 may also include bio data sensors 1400 that record and report pulse rate, heat, and other parameters. The sensors 210 may also be used for the gesture detection noted above or may be used as input devices by the wearer of the glove 200. That is, the wearer of the system 100 and glove 200 may be presented with a choice of inputs on the screen of the glasses 120 (heads up display) and may make a selection by activating one or more of the sensors 210, for example. The sensors 210 may also be used to manipulate images displayed by the system 100 on the heads up display (glasses 120) or provide inputs. For example, using the system 100 and the sensors 210, a maintenance checklist may be completed electronically on-site even in an environment (e.g., where greasy equipment must be handled) that prevents the use of conventional typing or touchscreen entry. Because of the network 150 connection, communication with an off-site expert may be carried out during the maintenance or repair operation via throat microphone 147 input, gestures, or the like and a speaker 1070. Each gesture or movement may also be recorded and automatically compared against an electronic check list to assure completion.

FIG. 3 depicts an extremity fitted device such as for example boots 300 including sensors 210 and devices 140 according to embodiments of the invention. The boots 300 may additionally be equipped with location sensors 310. The location sensors 310 may be GPS-based or provide distance to specific objects. FIG. 4 depicts a suit 400 including sensors 210 and devices 140 according to embodiments of the invention. The sensors 210 and devices 140 may be integrated into the material of the boots 300 or suit 400 or may be installed as patches. The boots 300 and suit 400, like the glove 200, may be coupled to the system 100 and to the glove 200. Each of the system 100, glove 200, boots 300, and suit 400 may be integrated and synchronized and may be synchronized with other devices such as a pad type display or smart phone. The sensors 210 of the boots 300 and suit 400 may include bio data sensors 1400 that obtain biometric data from the wearer or the wearer's environment and display information (e.g., the obtained data or instructions based on the obtained data) on the glasses 120 or transmit the data via the network 150. The devices 140 may be used to alert the wearer when other forms of communication are ineffective. For example, a vibrator 1050 in one of the boots 300 may vibrate to alert the wearer to a hazard. Based on the biometric data or environmental data obtained with the sensors 210, the wearer may be provided instructions on the glasses 120 to leave an area with toxic gas or to stop activity until blood pressure decreases.

The system 100 may be used to perform interactive processes. According to one embodiment, a training video may be displayed on the glasses 120 and completion of a test, via interaction of the wearer with one or more devices 140 (e.g., touch sensor 1300, voice recognition processor 1000, gesture sensor 900), may be required before the wearer may proceed to a process or a location. The training may include two-way communication with a subject matter expert via the network 150. While all the interaction and information presentation discussed above may be beneficial in most cases, there may be situations when potential distractions must be minimized for the safety of the wearer of the system 100, glove 200, boots 300, and suit 400. Thus, based on location determined according to the devices 140 or information regarding the existence of a hazardous condition received via the network 150, for example, the display on the glasses 120 (heads up display) may be shut down until the location or condition indicated by the information changes.

While one or more embodiments have been shown and described, modifications and substitutions may be made thereto without departing from the spirit and scope of the invention. Accordingly, it is to be understood that the present invention has been described by way of illustrations and not limitation.

1. A wearable information gathering and processing system, the system comprising:
an information obtaining device, the information obtaining device including a radio frequency identification (RFID) reader, an infra red (IR) detector, a global positioning system (GPS) receiver, a laser measurement device, microphone, and camera;
a processing device, the processing device including at least one of a voice recognition processor, a gesture recognition processor, IR processor or measurement data processor configured to process data from said information obtaining device; and
an information-providing device coupled to the processing device, the information-providing device including at least one of a heads up display, a speaker, or a vibrator.

2. The system according to claim 1, further comprising an extremity fitted device, wherein the vibrator is disposed therein and is configured to alert a wearer of a hazard based on the processing device determining the hazard.

3. The system according to claim 1, further comprising one or more sensors connected to said extremity fitted device, the one or more sensors configured to output a signal based on at least one of measuring bio data, experiencing a touch, or experiencing a movement.

4. The system according to claim 3, wherein at least one of the one or more sensors provides input to the gesture recognition processor.

5. The system according to claim 1, further comprising a suit, wherein the vibrator is disposed in the suit and is configured to alert a wearer of a hazard based on the processing device determining the hazard.

6. The system according to claim 5, further comprising one or more sensors integrated into the suit, the one or more sensors configured to output a signal based on at least one of measuring bio data, experiencing a touch, or experiencing a movement.

7. The system according to claim 1, wherein the microphone is a throat microphone and the voice recognition processor is configured to identify a wearer of the system based on an input from the throat microphone.

8. The system according to claim 1, wherein the information obtaining device includes a front camera configured to record front images or front video from a perspective front view of a wearer of the system and a back camera configured to record back images or back video from a perspective rear view behind the wearer.

9. The system according to claim 8, wherein the back images or the back video is displayed on the heads up display.

10. The system according to claim 8, wherein the processing device includes a context-based processor configured to determine contextually related images to the front images or the back images and to provide the contextually related images on the heads up display.

11. The system according to claim 10, wherein the contextually related images are augmented images displayed on the heads up display as overlaid images on the front images or the back images.

12. The system according to claim 1, wherein the IR detector is configured to determine a temperature during welding.

13. The system according to claim 12, wherein the temperature determined by the IR detector is displayed on the heads up display.

14. The system according to claim 1, wherein the laser measurement device is configured to determine a distance between objects and provides input to the heads up display.

15. The system according to claim 1, wherein the GPS receiver provides a location of a wearer of the system.

16. The system according to claim 15, wherein input from the GPS receiver is used to control an automatic shutdown of equipment or alarm based on a proximity of the wearer to the equipment.

17. The system according to claim 15, wherein the location of the wearer is transmitted to a monitoring controller.

18. The system according to claim 15, wherein the location of the wearer and a different location of a different wearer of a different system are used to triangulate a location of an object being detected by the system and the different system.

19. The system according to claim 15, wherein the data processor overlays information on the heads up display based on the location of the wearer.

20. The system according to claim 19, wherein the information includes exit and hazard information specific to the location.
